(19) United States
(12) Patent Application Publication
(10) Pub. No.: US 2006/0033079 A1
(43) Pub. Date: Feb. 16, 2006

(54) Noncombustible pre-mixture

(75) Inventors: Lothar Zipfel, Laatzen (DE); Karsten Boerner, Sehnde (DE); Dierk-Ingolf Recke, Wunstorf (DE)

Correspondence Address: CROWELL & MORING LLP;INTELLECTUAL PROPERTY GROUP, P.O. BOX 14300, WASHINGTON, DC, 20044-4300, US

(73) Assignee: SOLVAY FLUOR GMBH, Hannover (DE)

(21) Appl. No.: 11/207,824

(22) Filed: Aug. 22, 2005

Related U.S. Application Data
(63) Continuation of application No. PCT/EP04/01134, filed on Feb. 7, 2004.

(30) Foreign Application Priority Data
Feb. 22, 2003 (DE) 103 07 572.0

(51) Int. Cl. H01M 4/88

(52) U.S. Cl. 252/182.1

(57) ABSTRACT

A non-combustible polyether polyol and/or polyester polyol pre-mixture for producing a foamed product, expecially a polyurethane foam material, in which the pre-mixture comprises polyol, more than 4% by weight of a blowing agent mixture comprising HFC 365mfc and at least one additional fluorohydrocarbon blowing agent, and a halogenated alkane.

### CROSS REFERENCE TO RELATED APPLICATIONS

This application is a continuation of international patent application no. PCT/EP2004/001134, filed Feb. 7, 2004, designating the United States of America, and published in German as WO 2004/047358 on Sep. 2, 2004, the entire disclosure of which is incorporated herein by reference. Priority is claimed based on Federal Republic of Germany patent application no. DE 103 07 572.0, filed Feb. 22, 2003.

### BACKGROUND OF THE INVENTION

The present invention relates to noncombustible polyester polyol pre-mixtures and/or polyether pre-mixtures for producing foams, especially polyurethane foam products.

Polyurethane foams are produced by reacting isocyanates with a polyol or a polyol mixture in the presence of blowing agents, preferably hydrofluoroalkanes.

The use of 1,1,1,3,3-pentafluorobutane (HFC 365mfc) as blowing agent for producing polyurethane foams is known. Since 1,1,1,3,3-pentafluorobutane has a flash point of less than −27° C., it is regarded as an easily inflammable liquid and its use as a blowing agent is limited. Usually, therefore, 1,1,1,3,3-pentafluorobutane is used in a mixture with other fluorinated hydrocarbons.

Aside from HFC 365mfc, known blowing agent mixtures contain, for example, 1,1,1,2-tetrafluoroethane (HFC 134a) or 1,1,1,2,3,3,3-heptafluoropropane (HFC 227ea) or 1,1,1,3,3-pentafluoropropane (HFC 245fa). These blowing agent mixtures do not have a flashpoint and are suitable for producing foamed plastics.

WO 02/099006 describes a noncombustible composition of 1,1,1,3,3-pentafluorobutane, 1,1,1,3,3-pentafluoropropane and 1,2-dichloroethylene.

U.S. 2002/019822273 A 1 describes a blowing agent mixture, which does not have a flashpoint. Aside from the known, fluorine-containing blowing agents, this blowing agent mixture contains 2-chloropropane.

WO 00/56833 describes ternary and quaternary mixtures which, aside from 1,1,1,3,3-pentafluorobutane, also may contain N-propyl bromide.

In order to produce foams, it is also known and customary to produce initially so-called pre-mixtures from the various materials used. These pre-mixtures are then reacted with the isocyanate. In order to produce the pre-mixture, polyols or polyethers, blowing agents, catalysts and optionally further additives are mixed with one another in the required amounts. The foams are then produced by bringing the pre-mixture into contact with the isocyanate or isocyanates.

When the pre-mixtures are produced using the aforementioned blowing agents, it may happen, if critical amounts of blowing agent are exceeded, that because of the low flashpoint, the entire system is classified as combustible, although the blowing agent mixture and the polyol system separately are not combustible.

### SUMMARY OF THE INVENTION

It is an object of the invention to provide a noncombustible, stable pre-mixture for producing foams, in which the pre-mixture does not have a flashpoint.

This and other objects are achieved in accordance with the present invention by providing a noncombustible pre-mixture for producing a foam product, said pre-mixture comprising at least one polyether polyol and/or polyester polyol and at least one blowing agent, wherein said pre-mixture further comprises a halogenated alkane sufficient to increase the flashpoint and render the pre-mixture non-combustible.

Pursuant to the invention, the noncombustible pre-mixture for producing foam products from polyols, preferably from polyether polyols and/or polyester polyols, auxiliary materials additives such as a catalyst, a stabilizer, additives and blowing agents or a blowing agent mixture, is characterized in that this pre-mixture contains halogenated alkanes.

Pre-mixtures in accordance with the present invention preferably contain:
a) polyol, preferably polyether polyols or polyester polyols, and
b) 4 to 35% by weight, and preferably 10 to 15% by weight, of a blowing agent mixture, the blowing agent mixture containing HFC 365mfc and at least 5% by weight, and preferably 7 to 50% by weight, of a further fluorinated hydrocarbon, preferably HFC 134a, HFC 227ea or HFC 245fa,
   and are characterized by an addition of halogenated alkanes. With regard to the “halogenated alkanes”, “halogenated” preferably refers to substitution by chlorine or bromine.

Examples of halogenated alkanes which may be used include compounds selected from the group consisting of 1,2-dichloroethane, 2-chloropropane and 1-bromopropane.

The addition of phosphorous compounds as flame retardants is unnecessary and, preferably, phosphorous compounds are not used. However, additional, known flame retardants, based on phosphorous, may be used.

Further auxiliary materials, such as a catalyst, a stabilizer and other additives are mixed with the pre-mixture in a known manner.

The pre-mixture according to the invention is brought into contact with the isocyanate or isocyanates and foamed in a known manner.

Usually, in order to prepare polyurethane foams, polyisocyanates with, for example, 2 to 4 isocyanate groups, are used. Their synthesis and the basic chemicals used for their synthesis are known in the art.

These isocyanates contain an aliphatic hydrocarbon group with up to 18 carbon atoms, a cycloaliphatic hydrocarbon group with up to 15 carbon atoms, an aromatic hydrocarbon group with 6 to 15 carbon atoms or an araliphatic hydrocarbon group with 8 to 15 carbon atoms. Examples of starting components which are technically particularly preferred include 2,4- and 2,6-toluylene diisocyanate, diphenylmethane diisocyanate, polymethylenepolyphenyl isocyanate and mixtures thereof. So-called modified polyisocyanates, which contain carbodiimide groups, urethane groups, alophenate groups, isocyanate groups, urea groups or biuret groups, may also be used.

Other possible starting components include compounds with at least two hydrogen atoms, capable of reacting with isocyanates. These are, in particular, compounds with a molecular weight of 300 to 10,000, which preferably contain 2 to 8 hydroxyl groups and may, in addition, contain amino groups, thio groups or carboxyl groups.

As further adjuvants and auxiliary materials, additional chemical blowing agents, such as water, may be added to the system that is to be foamed. Catalysts, for example tertiary amines, such as dimethyl-cyclohexylamine, and/or organometallic compounds, may also be used. Surface active auxiliary materials, such as emulsifiers or foam stabilizers, for example, siloxane polyether copolymers, reaction retarders, cell regulators, such as paraffins, fatty alcohols or dimethylpolysiloxanes, pigments and dyes may be used. Furthermore, stabilizers to prevent aging and weathering, effects, fillers, dyes, antistatic agents, nucleating agents, pore-regulating substances or active ingredients with biocidal effects may be used.

Highly suitable catalysts are mentioned, for example, in published international patent application no. WO 96/14354. These include organic amines, aminoalcohols and aminoethers, such as morpholine compounds, for example, dimethylcyclohexylamine, diethanolamine, 2-dimethylaminoethyl-3-dimethylaminopropyl ether, 2-dimethylaminoethyl ether, 2,2-dimorpholinodiethyl ether, N,N-dimethylaminoethylmorpholine and N-dimethylmorpholin. Organometallic compounds, such as tin, cobalt or iron compounds, can also be used as catalysts. For example, tin dioctooate, cobalt naphthenate, dibutyl tin dilaurate and iron acetonyl acetate may be used.

The advantage of the pre-mixture according to the invention is that, due to the addition of halogenated alkanes, the dissolving behavior of the components evidently is modified, so that the flashpoint is increased, and the “flammable” classification is not applicable. Consequently, the pre-mixture according to the invention can be stored and transported more easily.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A noncombustible pre-mixture for producing a foam product, said pre-mixture comprising at least one polyether polyol and/or polyester polyol and at least one blowing agent, wherein said pre-mixture further comprises a halogenated alkane sufficient to increase the flashpoint and render the pre-mixture non-combustible.

2. A non-combustible pre-mixture according to claim 1, wherein said pre-mixture further comprises at least one auxiliary material selected from the group consisting of catalysts, stabilizers and additives.

3. A noncombustible pre-mixture according to claim 1, wherein said halogenated alkane is selected from the group consisting of 1,2-dichloroethane, 2-chloropropane, 1-bromopropane, and mixtures of two or more of the foregoing.

4. A noncombustible pre-mixture according to claim 1, wherein said blowing agent comprises a mixture of 1,1,1,3,3-pentafluorobutane (HFC-365mfc) and at least one further fluorinated hydrocarbon.

5. A noncombustible pre-mixture according to claim 4, wherein said further fluorinated hydrocarbon is selected from the group consisting of 1,1,1,2-tetrafluoroethane, 1,1,1,2,3,3,3-heptafluoropropane (HFC-227ea), and 1,1,1,3,3-pentafluoropropane (HFC-245fa).

6. A noncombustible pre-mixture according to claim 4, wherein the blowing agent mixture comprises at least 5% by weight of said further fluorinated hydrocarbon, the total blowing agent mixture being set as 100% by weight.

7. A noncombustible pre-mixture according to claim 6, wherein the blowing agent mixture comprises from 7 to 50% by weight of said further fluorinated hydrocarbon.

8. A noncombustible pre-mixture according to claim 5, wherein the blowing agent mixture comprises HFC-365mfc and at least one further blowing agent selected from the group consisting of 1,1,1,2-tetrafluoroethane (HFC-134a), 1,1,1,2,3,3,3-heptafluoropropane (HFC-227ea) and 1,1,1,3,3-pentafluoropropane (HFC-245fa).
